(19) United States
(12) Patent Application Publication
(10) Pub. No.: US 2021/0170568 A1
(43) Pub. Date: Jun. 10, 2021

(54) TOOLBOX

(71) Applicants: GRABBER CONSTRUCTION PRODUCTS, INC., Highland, UT (US); JENG YUH CO., LTD., Tainan City (TW)

(72) Inventor: Jui-Ming KO, Tainan City (TW)

(21) Appl. No.: 16/951,824

(22) Filed: Nov. 18, 2020

(30) Foreign Application Priority Data
Dec. 10, 2019 (TW) 108216419

(51) Int. Cl. B25H 3/02

(52) U.S. Cl. CPC B25H 3/025

(57) ABSTRACT

A toolbox includes a bottom portion with slots and a lid with latches. When closing the lid, the latches slide through the slots, each of which features a receiving edge and an unlock button at the bottom, vertically from above. The latches of the lid come with protruding stops and unlock buttons. As the latches are inserted into the slots, the stops fit into the receiving edges at the bottom of the slots, tightly combining the lid with the bottom portion.

### RELATED APPLICATION

This application hereby claims priority to Taiwanese Patent Application No. 108216419, filed Dec. 10, 2019, which is incorporated herein in its entirety by this reference.

### BACKGROUND OF THE INVENTION

### Field of the Invention

This invention relates to a toolbox. The concept is a bottom portion with slots and a lid with latches that, when combined, can be used as a storage box for tools.

### Description of the Prior Art

Commonly, in producing toolboxes with injection molding, the bottom portion and the lid being produced together as a piece, or the bottom portion and its lid being created separately, and later combined with hinges.

### SUMMARY OF THE INVENTION

The primary objective of this invention is to provide a toolbox that have a lid with extending latches and a bottom portion with slots, which are both designed to make it easier and more convenient for the lid and the box to engage.

The main characteristics of the invention is provides a kind of the bottom portion. The bottom portion provided with a storage space and slots on one side. The slots comprise a protruding inner part and an outer part. The lid that covers the bottom portion, while the lid have their one sides disposed with a latches that can be inserted into the slots of the bottom portion, while each the latch has a stop and an unlock button on it.

### BRIEF DESCRIPTION OF DRAWINGS

This invention will be understood by referring to the accompanying drawings, wherein:

FIG. 1 is a perspective view showing the exploded components of the toolbox according to the preferred embodiment of the present invention;

FIG. 2 is a perspective view showing the assembly of a toolbox according to a preferred embodiment of the present invention; and

FIG. 3 is a cross-sectional view of the slot receives the latch of the present invention.

### DETAILED DESCRIPTION OF THE PREFERRED EMBODIMENT

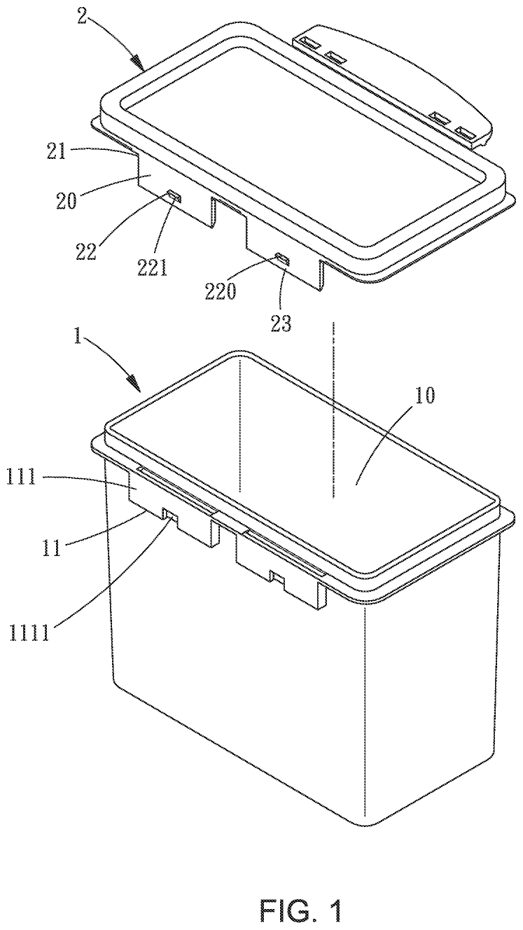

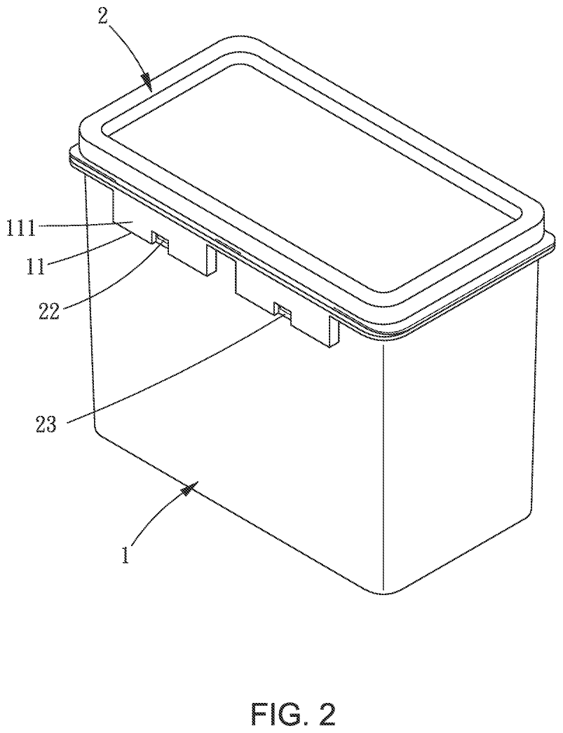

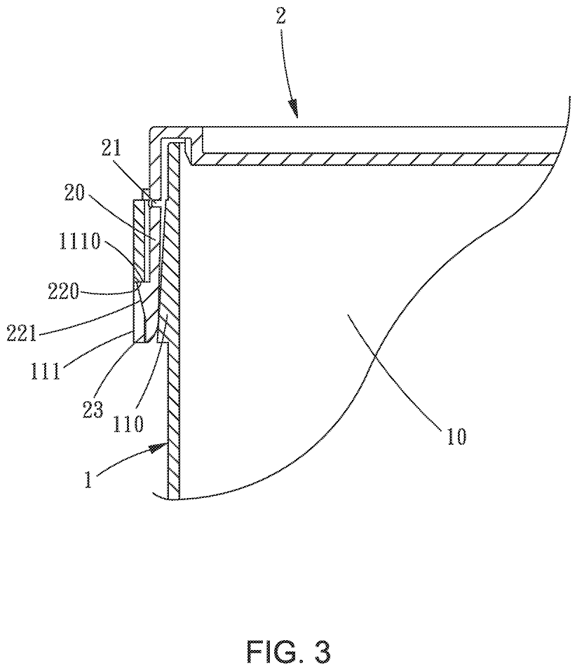

As shown in FIGS. 1 to 3, a preferred embodiment consists mainly of toolbox is includes a bottom portion 1 and a lid 2. The bottom portion 1 is provided with a storage space 10 and multiple slots 11, each of which consists of a protruding inner part 110 and an outer part 111 that has a receiving edge 1110 and a hollowed-out part 1111 at its center. A latch is designed to be inserted into the slots 11 vertically from above, which makes it easier to be ejected later. The lid 2 is positioned above the bottom portion 1, provided with a latches 20 that are slightly smaller with the corresponding slots 11. There is a hinge 21 at the point where a latches 20 joins the lid 2, while the part where latches 20 fit into the hollowed-out parts 1111 of slots 11 provided with stop face 220. Each stop 22 is further provided with a stop face 220 and a sliding face 221 at the top, and an unlock button 23 at the bottom.

To engage the lid 2 with the bottom portion 1, users only have to insert the latches 20 of the lid 2 into the slots 11 of the bottom portion 1. The slots 20 of the lid 2 are held in the hollowed-out part 1111 formed by the protruding inner part 110 and the outer part 111. After the stops 22 of the latches 20 slide through the outer part 111, their stop faces 220 are held in place by the receiving edges 1110 in the slots 11.

To separate the lid 2 and the bottom portion 1, users only have to press the unlock buttons 23 of the latches 20 attached to the lid 2, so the stop faces 220 of the latches 20 will be ejected from the receiving edges 1110 in the slots 11.

As can be seen from the above description, this invention has the following advantages:

1. The present invention allows the lid 2 to easily join the bottom portion 1. If either of the parts is broken, users only have to replace the broken one instead of buying a new one, thus saving cost.

2. The present invention features slots 11 of the bottom portion 1 that receive latches from above, making it easier to eject them later.

3. The present invention has bigger stops 22 of the lid 2 and larger receiving edges 1110, which helps the lid 2 to join better with the bottom portion 1.

While the preferred embodiment of the invention has been described above, it will be recognized and understood that various modifications may be made therein and the appended claims are intended to cover all such modifications that may fall within the spirit and scope of the invention.

What is claimed is:

1. A toolbox comprising:
a bottom portion, provided with a storage space and slots on one side, wherein the slots comprise a protruding inner part and an outer part; and
a lid that covers the bottom portion, while the lid have their one sides disposed with a latches that can be inserted into the slots of the bottom portion, while each the latch has a stop and an unlock button on it.

2. The toolbox according to claim 1, wherein the bottom portion that features multiple slots.

3. The toolbox according to claim 1, wherein the characterized by the correspondence of the number of latches to that of slots.

4. The toolbox according to claim 1, wherein the slots that consist of protruding inner parts and outer parts which comprise the receiving edges and hollowed-out parts. The protruding inner parts can serve as an outward pushing force that tightly holds the stops against the receiving edges.
